(19) United States
(12) Patent Application Publication
(10) Pub. No.: US 2012/0198570 A1
(43) Pub. Date: Aug. 2, 2012

(54) Geo-Enabled Access Control

(75) Inventors: David Joa, Irvine, CA (US); Debashis Ghosh, Charlotte, NC (US)

(73) Assignee: BANK OF AMERICA CORPORATION, Charlotte, NC (US)

(21) Appl. No.: 13/018,936

(22) Filed: Feb. 1, 2011

(51) Int. Cl. G06F 21/00

(52) U.S. Cl. 726/30

(57) ABSTRACT

Aspects described herein provide methods and systems that monitor mobile data processing devices used for remote access to a computer network or system, and allowing or preventing access to the computer system or network based at least in part on a determined geographical location of the mobile device. Different datasets stored on the network or system might have different geographical limitations associated with each. Different users also might have different geographic access limitations for the same dataset. User location may be based on GPS information associated with the device from which the user is attempting access, based on Wi-Fi, triangulation, or the like, or may be based on a photograph taken by the remote access device contemporaneously with the access request.

### FIELD OF THE INVENTION

The invention relates generally to remote access data processing systems. More specifically, the invention provides systems and methods for monitoring mobile data processing devices used for remote access to a computer network or system, and allowing or preventing access based at least in part on a determined geographical location of the mobile device.

### BACKGROUND OF THE INVENTION

As the feature sets of mobile data processing devices approach the capabilities of traditional desktop and laptop computers, there is an increased risk that a mobile computing device will be used to improperly access data that was previously only accessible by a conventional computer. For example, Citrix® Receiver by Citrix Systems, Inc. of Fort Lauderdale, Fla., is available for the iPhone®, which allows a user to remotely log in to his or her desktop or network server, thereby allowing the user complete access to anything the user could otherwise access from the desktop or server, regardless of the location of the iPhone®. Increased security controls are thus needed to address the increasing mobility of powerful data processing devices.

### BRIEF SUMMARY OF THE INVENTION

The following presents a simplified summary of the invention in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

To overcome limitations in the prior art described above, and to overcome other limitations that will be apparent upon reading and understanding the present specification, the present invention is directed to methods and systems that monitor mobile data processing devices used for remote access to a computer network or system, and allowing or preventing access to the computer system or network based at least in part on a determined geographical location of the mobile device.

According to a first aspect, a system performs a method that authorizes or denies access to a first dataset by receiving a request from a first portable access device for a first user to access a first dataset, determining a current location of the first portable access device, querying a location database to determine whether the current location of the first portable access device is an authorized location for the first user to access the first dataset, when the current location of the first portable access device is determined not to be an authorized location for the first user to access the first dataset, denying access to the first dataset, and when the current location of the first portable access device is determined to be an authorized location for the first user to access the first dataset, the system grants the first user access to the first dataset via the first portable access device, periodically determines a new current location of the first portable access device, and terminates access to the first dataset when the new current location of the first portable access device is not an authorized location for the first user to access the first dataset.

According to another aspect, two users might have different levels of access to the first dataset, such that one user might be allowed access the first dataset from a particular location, but a second user might not be authorized to access the first dataset from the same location. In another aspect, a single user might have different levels of access to different datasets, such that the one user might access the first dataset from a particular location, but the same user might not be authorized to access a second dataset from the same location.

According to some aspects, the location of the portable access device(s) might be based at least in part on a photograph taken by the portable access device contemporaneously with the access request, and with each subsequent access request. The system determining whether to grant or deny access may compare the photograph—and optionally analyze any geotag, date, and time metadata associated with the photograph—with a database of photos, the contents of which have known locations. The system confirms the photo received from the portable access device is authentic (as opposed to forwarded from a third party or taken at an earlier time) and then compares the photo to the database to determine the location of the portable access device.

According to some aspects, the method of determining access may be performed upon execution of computer readable instructions stored in a memory of the portable access device itself when the dataset resides on the portable access device, or by a server that controls access to the requested dataset at a remote location.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a system architecture that may be used to implement one or more illustrative features described herein.

FIG. 2 shows a flow chart of an illustrative method for determining whether to grant or deny access to a dataset based on a location of an accessing device according to one or more illustrative aspects of the invention.

FIG. 3 shows disparate locations that may be used to grant or deny access to one or more datasets according to one or more illustrative aspects of the invention.

FIG. 4 shows an expected path versus a deviated path, used to grant or deny access to one or more datasets, according to one or more illustrative aspects of the invention.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention. The invention is capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

As used throughout this description, the term “financial institution” and “bank” are used interchangeably. Aspects described herein are applicable to any institution or organization that provides access to computer systems and/or networks by remote, mobile, portable or roaming devices. The examples described herein with respect to a bank or financial institution are illustrative in nature only.

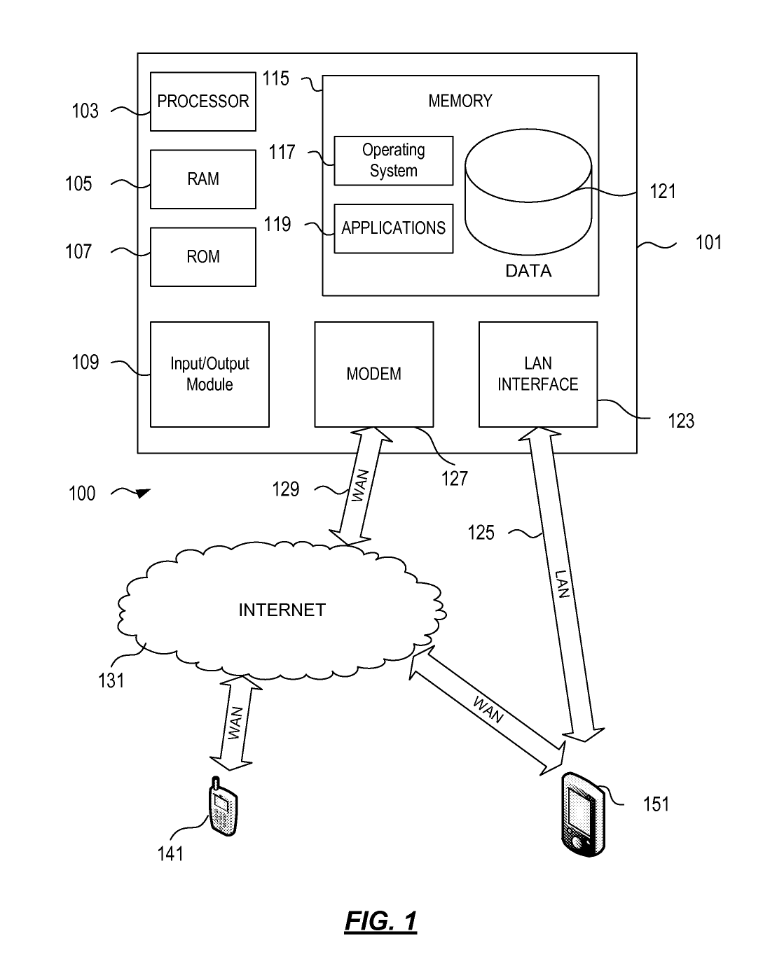

FIG. 1 illustrates a block diagram of a computing device 101 (e.g., a computer server, etc.) in computing environment 100 that may be used according to an illustrative embodiment of the disclosure. The computer server 101 may have a processor 103 for controlling overall operation of the server and its associated components, including random access memory (RAM) 105, read-only memory (ROM) 107, input/output (I/O) module 109, and memory 115.

I/O 109 may include a microphone, mouse, keypad, touch screen, scanner, optical reader, and/or stylus (or other input device(s)) through which a user of server 101 may provide input, and may also include one or more of a speaker for providing audio output and a video display device for providing textual, audiovisual and/or graphical output. Software may be stored within memory 115 and/or other storage to provide instructions to processor 103 for enabling server 101 to perform various functions. For example, memory 115 may store software used by server 101, such as operating system 117, application programs 119, and associated database 121. Alternatively, some or all of server 101 computer executable instructions may be embodied in hardware or firmware (not shown).

Server 101 may operate in a networked environment supporting connections to or by one or more remote, mobile, and/or roaming data processing devices, such as terminals 141 and 151. Devices 141, 151 may be personal computers or servers that include many or all of the elements described above relative to the server 101; devices 101, 141, 151 may also include mobile data processing devices, smartphones, mobile telephones, personal digital assistants, portable computers and the like, which are referring to collectively generically herein as portable access devices (PAD). The network connections depicted in FIG. 1 include a local area network (LAN) 125 and a wide area network (WAN) 129, but may also include other wired or wireless networks, and the like, to provide a comprehensive network for a financial institution. Such a network may be referred to as a financial services network. When used in a LAN networking environment, the computer 101 may be connected to LAN 125 through a network interface or adapter 123. When used in a WAN networking environment, the server 101 may include a modem 127 or other wired or wireless network interface for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by one or more computers and/or one or more processors associated with the computers. Generally, program modules include routines, programs, objects, components, data structures, etc., that perform particular tasks or implement particular abstract data types. Aspects of the disclosure may also be practiced in distributed computing environments where tasks are performed by remote processing devices that are linked through a communications network. In a distributed computing environment, program modules may be located in both local and remote computer storage media including memory storage devices.

The above-described systems may be used in various financial institutions, such as banks, etc., to monitor and provide secure access to one or more computer networks or systems. As indicated above, a portable access device (PAD) may include any device capable of being easily moved, e.g., laptop computers, mobile phones, etc. There are many situations, however, where an organization may desire to prevent access to a network or to specific data based on a known location of a given PAD attempting to access the network or data. For example, in a financial institution, one line of business (LOB) might not be able to see or use data belonging to separate lines of business. A global wealth investment management (GWIM) LOB might not be able to see or view data belonging to a global corporate investment banking (GCIB) LOB, and vice versa. However, present systems do not prevent an employee of one line of business (e.g., GWIM) from logging in from a location within the physical office space of the other line of business (e.g., GCIB), thereby allowing GCIB employees to view the GWIM data. Using one or more aspects described herein, if someone from GWIM were to stray into a GCIB designated workplace, the GWIM employee's access to data may be restricted so that there is no inadvertent sharing with or snooping by GCIB employees.

Another example is when two departments of an organization are not permitted to share certain data. For example, a department that makes lending decisions might not be allowed to consider race, gender, and other specified biographical data. However, if the person requesting the loan or line of credit is already a customer of the organization, the organization might already have this information in its databases, and thus need to prevent access by unauthorized personnel or at unauthorized locations, e.g., by loan underwriters making a lending decision. While the organization might already restrict access to biographical information by loan underwriters, e.g., using field-level access control in the organization's databases, it is possible for an authorized person to access the data in the presence of the loan underwriter, thereby providing the loan underwriter improper access to the biographical information. According to an aspect, access may be restricted based at least in part on the geographical location of the person or device attempting to access a given data set. The organization may thus maintain a single portal including marketing, risk, management, private banking, mass markets, and other financial institution information, while maintaining a higher degree of security than previously possible by limiting access to datasets based on the geographic location from which access is requested. Information sharing can be limited where prohibited, e.g., by federal or state statute, regulation, and/or business rules. In one example a person applying for a mortgage might call a toll-free number which is routed to a service center located in Simi Valley, Calif. The Simi Valley location that houses the intake of the call may be geo-coded with data limiting capabilities such that users at Simi Valley only receive data that is authorized for access at that location (e.g., stripped of race, gender, age information) instead of or in addition to any software applications deployed to filter access.

Consider yet another illustrative scenario where two competing organizations may be located proximately to each other. One organization may desire to prevent access to its datasets from a device located in the known geographic boundaries of the competitor's offices. By requiring an accessing device to provide validated location information prior to accessing data, the first organization can prevent an employee from simply carrying his or her portable access device (PAD) to the competitor's offices, logging in to the dataset from the PAD, and displaying the data for the competitor to review and use in any number of unknown and possibly illegal ways.

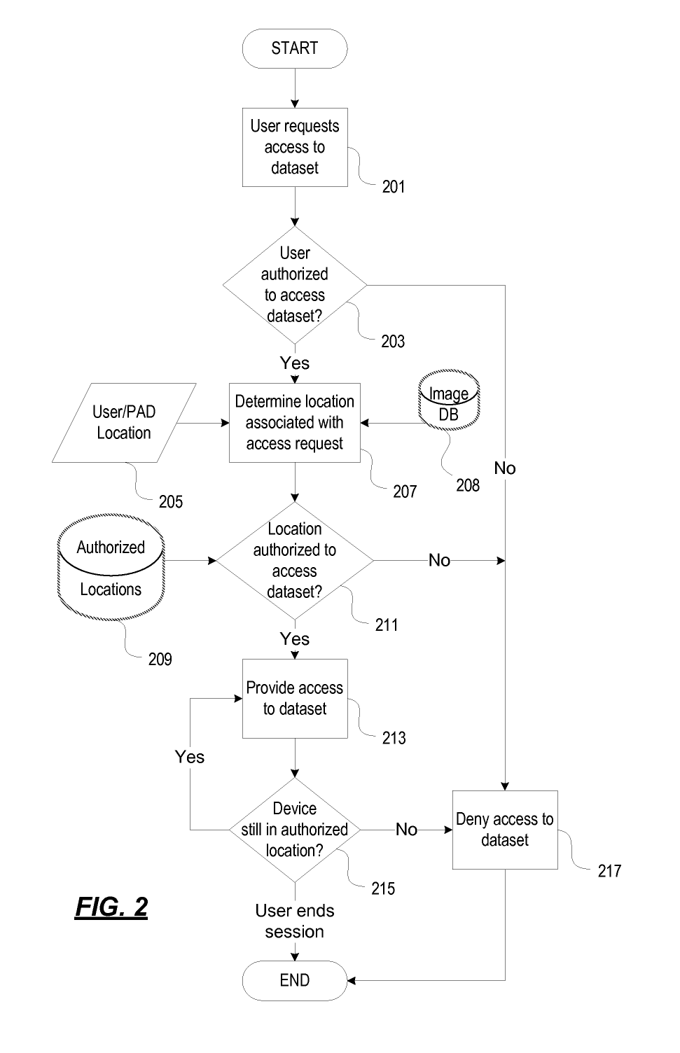

FIG. 2 illustrates a flow chart of a method of determining access to a dataset based at least in part of a geographic location of the user or PAD attempting to access the dataset. As used herein, a dataset is any set of data to which access may be restricted based on geographical location as described herein. For example, a dataset may be all or a subset of data on a network, all or a subset of data in one or more databases, and/or all or a subset of data fields in a database. A dataset is any set of data that may be defined or filtered for access by a user. The method of FIG. 2 may be used, e.g., to prevent cross-contamination of data by line of business, department, division, or other business units, as well as prevent data loss from outside the physical campus of the organization, and may be executed in application software 119 at a dataset server, e.g., computer 101, when access is requested to a dataset located in database 121.

In step 201a user requests access to a dataset. Access may be based on a user ID or based on a role associated with a user. A user role refers to a set of permissions given to a group of users having similar responsibilities, e.g., all users having the role of “manager” receive permissions A, B, and C, whereas all users having the role of “director” might have permissions A, B, C, and D. The user or user role may be defined or identified by a username/password combination, a mac address or other address of a specific device requesting access where the address is associated with a specific user or role, biometric information, or by any other known or to be developed method of mechanism to identify a user or user role. In step 203, the system determines if the user or role is authorized to access the dataset for which access is requested. If so, the method proceeds to step 205. If not, the method proceeds to step 217, where access is denied.

In step 207 the system determines a location identified with the access request. The determination in step 207 may be based on location information 205 received from the device requesting access to the dataset. Alternatively, location information 205 may be retrieved by the system based on a network address of the device requesting access by looking up the address in a database that correlates a known device address to a corresponding specific location. For example, if the device requesting access is not a PAD, but is instead a fixed location computer that is not feasibly moved from one location to another, the system might already know or be able to look up the fixed location of the device without the need to receive location information from the requesting device.

However, when the device requesting access to the dataset is a PAD, the device may be required to provide verifiable or trustworthy location information identifying the location of the PAD prior to and/or during access to the dataset. Such location information may include location information received from a secure or tamper-proof global positioning system (GPS) chipset, be based on triangulation, recognition of known local wireless networks, or based on other trustworthy location identifying information received from the PAD. Each type of location information is associated with a degree of error. The degree of error may be defined by an administrator, or based on the type of technology used to identify the location. For example, the degree of error associated with GPD may be plus or minus 15 feet; the degree of error associated with triangulation may vary from, e.g., plus or minus 25 feet to plus or minus 75 feet depending on a degree of confidence that may be associated with the triangulation result; and the degree of error associated with a location of a known wireless network may be plus or minus 300 feet. When two or more local known wireless networks are detected by the location determination unit on the PAD, triangulation may be used to further refine location information 205 provided to the system.

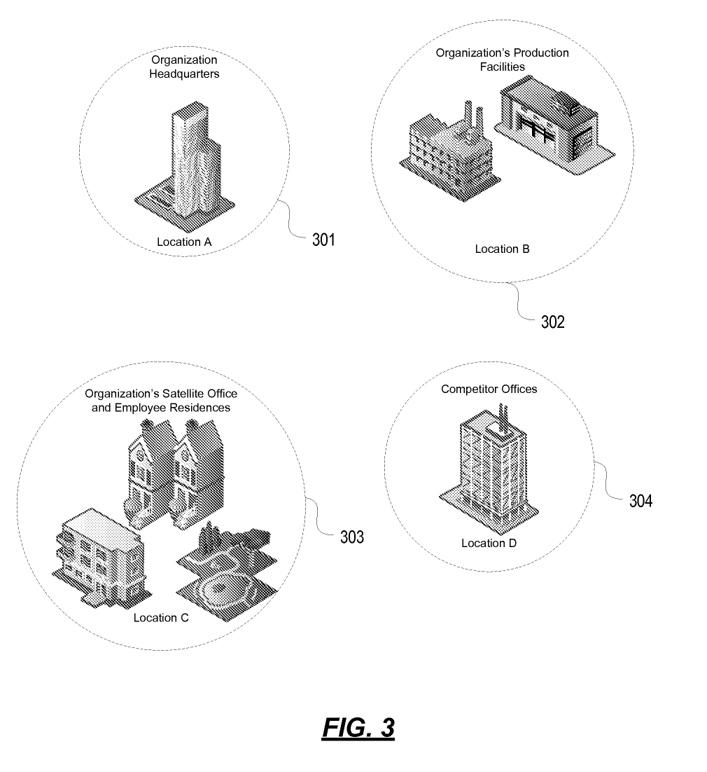

In step 211, the system determines whether the location associated with the device requesting access is allowed to access the requested dataset. If any location within the degree of error associated with the location information is within an unauthorized area, then access may be denied. The system may perform the authorization determination by querying database 209 which stores authorized location information for each dataset subject to additional location security as described herein. Database 209 may indicate, for each dataset, positive or negative location limitations. A positive limitation is an indication that the requested dataset is accessible from one or more specific locations (e.g., “+A, +B, +C” means only from Locations A, B and C, 301-303, FIG. 3). A negative limitation is an indication that the requested dataset is not accessible from one or more specific locations (e.g., “−D” mean from any location other than Location D, 304, FIG. 3). When only positive limitations are used, access is granted only when the PAD location is within one of the specified authorized locations. When only negative locations are used, access is granted unless the PAD location is within one of the specified locations. Positive and negative limitations generally are not usable together due to the resulting ambiguity.

When positive and negative limitations are used together with respect to the same dataset, then positive limitations generally take precedence over negative limitations, and all unmentioned locations are treated as unauthorized locations. Thus, if database 209 indicates that the dataset is accessible only from locations A, B, and C, and also indicates that the dataset is not accessible from locations C and D (e.g., “+A, +B, +C, −C, −D”), then the result may be that access is granted only from locations A and B and nowhere else. This situation should be avoided, however, due to the inherent ambiguity, and database 209 might have one or more input controls preventing such a scenario from occurring.

Upon querying database 209, the system in step 211 determines whether location 205 is authorized to access the requested dataset. If the location is not authorized to access the dataset, then the method proceeds to step 217 where access to the dataset is denied. If the location is authorized to access the dataset, then in step 213 the system provides the user/PAD the requested access to the dataset. The system may optionally periodically check to determine whether the device moves or remains in an authorized location in step 215, thereby disabling access to the dataset if the PAD moves to a location that is no longer authorized to access the dataset.

Using the method of FIG. 2, access to a dataset can be restricted based on a location from where access is requested. For example, access can be restricted to or from a particular organization, department, or the like. Variations may be made to the method of FIG. 2 without departing from aspects of the invention described herein. For example, the dataset might be located on the PAD itself. That is, a user might be restricted from accessing data on his or her own computer or other mobile device based on the current location of the device, so that the user cannot move or carry the device to an unauthorized location and retrieve data for an improper purpose (such as showing the data to an unauthorized employee or competitor).

In addition, different levels of access control may be provided based on user authority level. A first level user, e.g., an analyst, might only be able to access data while in his or her department's physical office space; a second level user, e.g., a manager, might be able to access the same data from anywhere within the organization's physical office space; a third level user, e.g., a director, might be able to access the same data from anywhere other than a known competitor's office space; and a fourth level user, e.g., vice-president and above, might be able to access the same data from anywhere. If, after access is granted, the user moves to an unauthorized location, the screen (and other output ports and devices) may be disabled to prevent unauthorized disclosure.

In yet another alternative, the system or application controlling dataset access might require the user to prove or validate his or her location by taking a photograph using a camera integrated into the PAD. According to this aspect, User/PAD location information 205 (FIG. 2) includes the photograph and optionally metadata associated with the photograph (e.g., geo-tag information, date/time of photo, shutter speed, etc.). The controlling application 119 (irrespective of whether application 119 is located in server 101 or in PAD 141, 151) in step 211 may compare the image to a database 208 of known images to confirm the image was taken from a particular location or within range of a predetermined landmark, and thereby validate the user/PAD location based on the image. The user can thus take a photograph and submit the photograph to application 119 to confirm his or her position. The use of geo-tag and date/time information may be used to confirm the user is not simply forwarding a photo received from a third party. Alternatively, application 119 executing on the PAD 141, 151 may control the camera during the picture taking process, and only accept as input an image received directly from the camera hardware on PAD 141, 151. Application 119 then proceeds in step 211 as described above to grant or deny the user/PAD access to the dataset. According to one variation, the user might be required to submit a photo of a particular image (e.g., unique artwork, architecture, scenery, coded image, barcode, 2-D barcode, etc.) known to be displayed at a specific location, in order to gain access to a particular dataset. That is, the database 208 might only contain specific images or information, and the user must submit a photo that resolves against an image in database 208. In yet another alternative, database 208 may include or use a commercial image identification service such as GOOGLE GOGGLES by Google, Inc., of Mountain View, Calif.

Different datasets can be restricted based on different combinations of user authority level and geographic areas. Thus, certain data fields, e.g., an account number, might be accessible virtually anywhere. However, other data fields, e.g., social security number and balance, might be restricted to access in fewer geographical areas and/or by users with higher authorization levels. Any combination of geographic location and user access level can be used for each dataset, from individual fields of a database records, to entire network repositories.

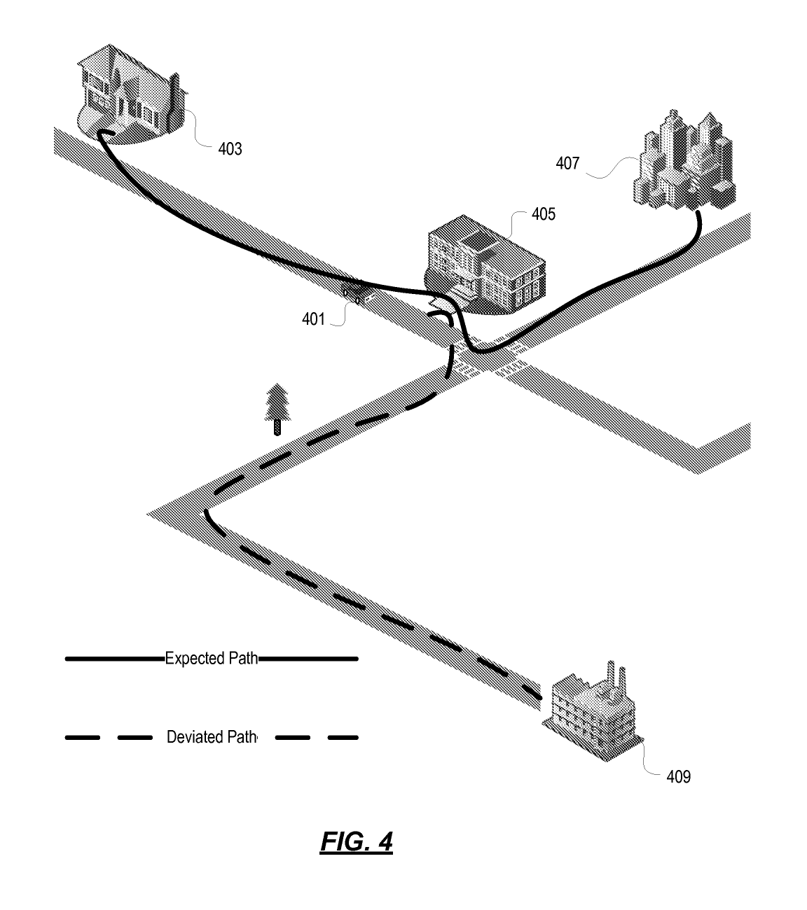

According to another aspect, the system may dynamically restrict access to financial information based on a monitored location of a PAD versus an expected location of the PAD. With reference to FIG. 4, a user (e.g., consumer, organization employee, vendor, or other person) might regularly travel a specified route throughout the day, e.g., commuting to/from work, grocery shopping and other errands, taking kids to school and/or other activities, organizational meetings, and the like. Alternatively, the user may input a route into a designated web site, and grant the organization authorization to monitor the location of the PAD associated with that user as the user goes about his or her day. In the example shown in FIG. 4, a user 401 might indicate that a planned route is to leave home 403, drop the kids off at school 405, and commute to work in city 407. The user does not plan to and might not regularly go to an industrial region 409 due to higher criminal activity in that area.

If the PAD's actual location varies beyond a predefined amount, distance, percentage, etc., from the input or expected route, the organization may cut off the user's access to specific data on the PAD and/or on the organization's network. For example, if the organization is a bank, and if the location of the user's PAD deviates to a location or region associated with a high percentage of fraudulent credit card transactions (e.g., industrial region 409), the organization might cut off access to a financial transaction application on the PAD, thereby preventing the PAD from being used for financial transactions until the lawful owner of the PAD confirms to the organization that the PAD is still in his/her possession, e.g., by contacting the organization via phone, or by accessing a password controlled website where the user is forced to enter his or her password and optionally also enter additional security information (e.g., answer a secret question). In this manner, the system may shut off access to contactless payment systems, an electronic bank wallet, electronic bank access, remote network access, and other financial services systems integrated into the PAD when the PAD deviates from the consumer's or employee's expected route of travel. The expected route of travel may be based on user input specifically defining an intended route, or may be based on fuzzy logic and/or other heuristics created based on monitoring the PAD's location over time.

With the added geographical layer of security as described herein, an organization may selectively enable and disable access to one or more different datasets based on where an accessing device is located, regardless of whether the accessing device has a network connection or not. That is, even with no network connectivity, the geographical security described herein may be integrated within device 141, 151 itself, thereby alleviating risk of data loss and data misappropriation based on geotag information.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, comprising:
receiving a request from a first portable access device for a first user to access a first dataset stored in a financial services network;
determining a current location of the first portable access device;
querying a location database to determine whether the current location of the first portable access device is an authorized location for the first user to access the first dataset in the financial services network;
when the current location of the first portable access device is determined not to be an authorized location for the first user to access the first dataset, denying access to the first dataset; and
when the current location of the first portable access device is determined to be an authorized location for the first user to access the first dataset:
granting the first user access to the first dataset via the first portable access device,
periodically determining a new current location of the first portable access device, and
terminating access to the first dataset when the new current location of the first portable access device is not an authorized location for the first user to access the first dataset.

2. The method of claim 1, further comprising:
receiving a request from a second portable access device for a second user to access the first dataset;
determining a current location of the second portable access device, wherein the current location of the second portable access device is the same as the current location of the first portable access device;
querying the location database to determine whether the current location of the second portable access device is an authorized location for the second user to access the first dataset;
determining, based on the querying, that the current location of the first portable access device is an authorized location for the first user to access the first dataset; and
determining, based on the querying, that the current location of the second portable access device is not an authorized location for the second user to access the first dataset.

3. The method of claim 1, further comprising:
receiving a request from the first portable access device for the first user to access a second dataset;
querying the location database to determine whether the current location of the first portable access device is an authorized location for the first user to access the second dataset;
determining, based on the querying, that the current location of the first portable access device is an authorized location for the first user to access the first dataset; and
determining, based on the querying, that the current location of the first portable access device is not an authorized location for the first user to access the second dataset.

4. The method of claim 1, wherein the request from the first portable access device for the first user to access the first dataset comprises image data, said method further comprising:
determining that the image was taken by a camera associated with the first portable access device; and
determining the current location of the first portable access device based on the image data.

5. The method of claim 4, wherein determining the current location of the first portable access device based on the image data comprises comparing a photo stored in the image data to a database of photographs having known locations to confirm that the picture was taken at a particular location.

6. The method of claim 4, wherein determining the current location of the first portable access device based on the image data comprises analyzing geo-tag, date and time metadata stored in the image data.

7. The method of claim 1, wherein said method is performed by the first portable access device.

8. One or more non-transitory computer readable media storing computer executable instructions that, when executed, cause a system to perform:
receiving a request from a first portable access device for a first user to access a first dataset;
determining a current location of the first portable access device;
querying a location database to determine whether the current location of the first portable access device is an authorized location for the first user to access the first dataset;
when the current location of the first portable access device is determined not to be an authorized location for the first user to access the first dataset, denying access to the first dataset; and
when the current location of the first portable access device is determined to be an authorized location for the first user to access the first dataset:
granting the first user access to the first dataset via the first portable access device,
periodically determining a new current location of the first portable access device, and
terminating access to the first dataset when the new current location of the first portable access device is not an authorized location for the first user to access the first dataset.

9. The computer readable media of claim 8, said instructions further comprising:
receiving a request from a second portable access device for a second user to access the first dataset;
determining a current location of the second portable access device, wherein the current location of the second portable access device is the same as the current location of the first portable access device;
querying the location database to determine whether the current location of the second portable access device is an authorized location for the second user to access the first dataset;
determining, based on the querying, that the current location of the first portable access device is an authorized location for the first user to access the first dataset; and
determining, based on the querying, that the current location of the second portable access device is not an authorized location for the second user to access the first dataset.

10. The computer readable media of claim 8, said instructions further comprising:
receiving a request from the first portable access device for the first user to access a second dataset;
querying the location database to determine whether the current location of the first portable access device is an authorized location for the first user to access the second dataset;
determining, based on the querying, that the current location of the first portable access device is an authorized location for the first user to access the first dataset; and
determining, based on the querying, that the current location of the first portable access device is not an authorized location for the first user to access the second dataset.

11. The computer readable media of claim 8, wherein the request from the first portable access device for the first user to access the first dataset comprises image data, said instructions further comprising:
determining that the image was taken by a camera associated with the first portable access device; and
determining the current location of the first portable access device based on the image data.

12. The computer readable media of claim 11, wherein determining the current location of the first portable access device based on the image data comprises comparing a photo stored in the image data to a database of photographs having known locations to confirm that the picture was taken at a particular location.

13. The computer readable media of claim 11, wherein determining the current location of the first portable access device based on the image data comprises analyzing geo-tag, date and time metadata stored in the image data.

14. The computer readable media of claim 11, wherein the system is the first portable access device.

15. A portable access device, comprising:
a processor controlling operations of the portable access device;
memory storing a database of authorized locations for access to a plurality of datasets, and further storing computer readable instructions that, when executed, cause the portable access device to perform:
receiving a request from a first user to access a first dataset stored on the portable access device;
determining a current location of the portable access device;
querying the database to determine whether the current location of the portable access device is an authorized location for the first user to access the first dataset;
when the current location of the portable access device is determined not to be an authorized location for the first user to access the first dataset, denying access to the first dataset; and
when the current location of the portable access device is determined to be an authorized location for the first user to access the first dataset:
granting the first user access to the first dataset,
periodically determining a new current location of the portable access device, and
terminating access to the first dataset when the new current location of the portable access device is not an authorized location for the first user to access the first dataset.

16. The portable access device of claim 15, said instructions further causing the portable access device to perform:
receiving a request for a second user to access the first dataset;
querying the database to determine whether the current location of the portable access device is an authorized location for the second user to access the first dataset;
determining, based on the querying, that the current location of the portable access device is an authorized location for the first user to access the first dataset; and
determining, based on the querying, that the current location of the portable access device is not an authorized location for the second user to access the first dataset.

17. The portable access device of claim 15, said instructions further causing the portable access device to perform:
receiving a request for the first user to access a second dataset;
determining, based on querying the database, that the current location of the portable access device is an authorized location for the first user to access the first dataset; and
determining, based on querying the database, that the current location of the portable access device is not an authorized location for the first user to access the second dataset.

18. The portable access device of claim 15, wherein the request for the first user to access the first dataset comprises image data, said instructions further causing the portable access device to perform:
determining that the image data was generated, contemporaneously with the request, by a camera associated with the portable access device; and
determining the current location of the first portable access device based on the image data.

19. The portable access device of claim 18, wherein determining the current location of the portable access device based on the image data comprises comparing a photo stored in the image data to a database of photographs having known locations to confirm that the picture was taken at a particular location.

20. The portable access device of claim 18, wherein determining the current location of the portable access device based on the image data comprises analyzing geo-tag, date and time metadata stored in the image data.
